(19) United States
(12) Patent Application Publication
(10) Pub. No.: US 2026/0161458 A1
(43) Pub. Date: Jun. 11, 2026

(54) DATA PROCESSING METHOD, APPARATUS AND SYSTEM

(71) Applicant: BOE Technology Group Co., Ltd., Beijing (CN)

(72) Inventors: Hongda YU, Beijing (CN); Hongjun DU, Beijing (CN); Tao LI, Beijing (CN); Huailiang WANG, Beijing (CN); Haitao ZHENG, Beijing (CN); Gao JI, Beijing (CN); Shiye LI, Beijing (CN); Guoqi LI, Beijing (CN); Zhi LI, Beijing (CN)

(21) Appl. No.: 18/703,823

(22) PCT Filed: Apr. 28, 2023
(86) PCT No.: PCT/CN2023/091466

§ 371 Date: Apr. 23, 2024

(30) Foreign Application Priority Data
Jun. 23, 2022 (CN) 202210719647.4

(51) Int. Cl. G06F 9/50

(52) U.S. Cl. CPC G06F 9/5027

(57) ABSTRACT

A method for processing data is applied to a target processing node in a system for processing data. The system for processing data includes a first relay node, at least one request node and at least one processing node, the target processing node is any one of the at least one processing node, and the method includes: receiving a data processing request sent by the first relay node, where the data processing request is sent to the first relay node by a target request node based on data to be processed of the system for processing data, and the target request node is any one of the at least one request node; executing a data processing operation requested by the data processing request; and transmitting a processing result of the data processing operation to the target request node.

The present disclosure is a US national stage of international application No. PCT/CN2023/091466, filed on Apr. 28, 2023, which claims priority to Chinese Patent Application No. 202210719647.4, filed on Jun. 23, 2022, and entitled “DATA PROCESSING METHOD, APPARATUS, AND SYSTEM”, the disclosures of which is herein incorporated by reference in their entireties.

### TECHNICAL FIELD

The present disclosure relates to the field of computer technologies, in particular, relates to a method, an apparatus, and a system for processing data.

### BACKGROUND

With the development of computer technology, data processing has become an indispensable step in various fields. For example, in the Internet of Things (IOT) field, multiple IoT devices often use data in different formats, and thus it is necessary to process these different formats of data to standardize the data format.

In the related art, a device for processing data is used to receive the data to be processed and carry out the processing of the data. For example, a device for processing data is used to receive data in different formats sent by multiple IoT devices and perform format conversion on each piece of received data so as to convert these data formats into a unified format.

However, current methods for processing data are simplistic.

### SUMMARY

The present disclosure provides a method, an apparatus, and a system for processing data that can solve the issue of current methods for processing data being simplistic. The technical solutions are as follows.

In a first aspect, a method for processing data is provided. The method is applied to a target processing node in a system for processing data, and the system for processing data includes a first relay node, at least one request node, and at least one processing node, and the target processing node is any one of the at least one processing node. The method includes:
receiving a data processing request sent by the first relay node, where the data processing request is sent to the first relay node by a target request node based on data to be processed of the system for processing data, and the target request node is any one of the at least one request node;
executing a data processing operation requested by the data processing request; and
transmitting a processing result of the data processing operation to the target request node.

Optionally, the system for processing data further comprises a second relay node, and the transmitting the processing result of the data processing operation to the target request node includes:
sending the processing result to the second relay node; and
sending a data processing response of the data processing request to the first relay node, such that the first relay node sends the data processing response to the target request node, and the target request node acquires the processing result from the second relay node based on the data processing response, where the data processing response is used to indicate that the processing result has been obtained.

Optionally, the data processing request carries an identifier of a script corresponding to the data processing request; and the script corresponding to the data processing request is a script that needs to be run to execute the data processing operation requested by the data processing request; and
the executing the data processing operation requested by the data processing request includes:
using a processing unit, which has been created within the processing node and is configured to run the script corresponding to the data processing request, to execute the data processing operation.

Optionally, the data processing request sent by the first relay node includes different data processing requests corresponding to a same script and data processing operations requested by the different data processing requests are executed by a same processing unit.

Optionally, the method further includes:
determining a first number of the data processing requests received within a most recent first time period for many times;
increasing the processing unit in the target processing node, in a case that a growth rate of the first number is greater than a first probability threshold, where the first probability threshold is greater than zero; and
decreasing the processing unit in the target processing node in a case that the growth rate of the first number is less than a second probability threshold, where the second probability threshold is less than zero.

Optionally, the method further includes:
determining a second number of the data processing requests corresponding to the same script received within a most recent second time period for many times;
increasing a processing unit for running the same script in the target processing node, in a case that a growth rate of the second number is greater than a third probability threshold, where the third probability threshold is greater than zero; and
decreasing a processing unit for running the same script in the target processing node, in a case that the growth rate of the second number is less than a fourth probability threshold, where the fourth probability threshold is less than zero.

Optionally, the system for processing data further includes a second relay node, and the target processing node is configured to:
execute x script acquisition operations to obtain n scripts for m processing units to run, in a case that the m processing units in the processing node are increased, wherein m≥x≥n≥1, one said script acquisition operation corresponds to one script out of the n scripts, and the script acquisition operation is configured to: acquire a corresponding script from a memory, in a case that the corresponding script is stored in the memory of the target processing unit; send an acquisition request for a corresponding script to the second relay node and receive the corresponding script sent by the second relay node based on the acquisition request, in a case that the corresponding script is not stored in the memory; and
create the m processing units based on the n scripts.

Optionally, m>x=n.

Optionally, the method further includes:
conducting statistics on frequency at which each script stored in the memory and the second relay node is run;
moving a first script stored in the second relay node from the second relay node to the memory, in a cast that the first script is run at a frequency greater than a first frequency threshold; and
moving a second script stored in the memory from the memory to the second relay node, in a cast that the second script is run at a frequency greater than a second frequency threshold and less than or equal to the first frequency threshold.

Optionally, before executing the data processing operation requested by the data processing request, the method further includes:
determining processing units in the processing node that are respectively configured to run scripts corresponding to multiple data processing requests, by using multiple threads in parallel and according to the multiple data processing requests, upon receiving the multiple data processing requests sent by the first relay node.

In a second aspect, a method for processing data is provided. The method is applied to a first relay node in a system for processing data, and the system for processing data further includes at least one request node and at least one processing node. The method includes:
receiving a data processing request sent by a target request node, wherein the data processing request is sent by the target request node based on data to be processed of the system for processing data, and the target request node is any one of the at least one request node; and
sending the data processing request to a target processing node, such that the target processing node executes a data processing operation requested by the data processing request and transmits a processing result of the data processing operation to the target request node, and the target processing node is any one of the at least one processing node.

Optionally, the system for processing data further includes a second relay node, the target processing node is configured to send the processing result to the second relay node, and the method further includes:
receiving a data processing response of the data processing request sent by the target processing node, where the data processing response is used to indicate that the processing result has been obtained; and
sending the data processing response to the target request node, such that the target request node acquires the processing result from the second relay node based on the data processing response.

Optionally, the sending the data processing request to the target processing node, includes:
sending a first data processing request in multiple data processing requests to the target processing node, upon receiving the multiple data processing requests sent by the target request node; and
sending a second data processing request in the multiple data processing requests to the target processing node, upon receiving a data processing response of the first data processing request.

Optionally, after receiving a data processing request sent by the target request node, the method further includes:
adding the data processing request to a first queue;
the sending the data processing request to the target processing node includes:
sending the data processing request in the first queue to the target processing node;
after receiving a data processing response of the data processing request sent by the target processing node, the method further includes:
adding the data processing response to a second queue; and
the sending the data processing response to the target request node includes:
sending the data processing response from the second queue to the target request node.
In a third aspect, a method for processing data is provided. The method is applied to a target request node in a system for processing data, and the system for processing data includes a first relay node, at least one request node, and at least one processing node, and the target request node is any one of the at least one request node. The method includes:
acquiring data to be processed of the system for processing data;
sending a data processing request to the first relay node based on the data to be processed, such that the first relay node sends the data processing request to a target processing node, the target processing node executes a data processing operation requested by the data processing request, and the target processing node is any one of the at least one processing node; and
acquiring a processing result of the data processing operation from the target processing node.

Optionally, the system for processing data further includes a second relay node, and the target processing node is configured to send the processing result to the second relay node and send a data processing response of the data processing request to the first relay node, where the data processing response is used to indicate that the processing result has been obtained;

the acquiring the processing result of the data processing operation from the target processing node includes:
receiving the data processing response sent by the first relay node; and
acquiring the processing result from the second relay node, based on the data processing response.

In a fourth aspect, an apparatus for processing data is provided. The apparatus for processing data includes a processor and a memory device, wherein the memory device stores programs, and the processor is configured to run the programs stored in the memory device to implement the method for processing data as defined in any one of the designs in the first aspect, the second aspect, or the third aspect.

In a fifth aspect, a system for processing data is provided. The system for processing data includes a first relay node, at least one request node, and at least one processing node, wherein the processing node is configured to perform the method for processing data as defined in any one of the designs in the first aspect;

the first relay node is configured to perform the method for processing data as defined in any one of the designs in the second aspect; and the request node is configured to perform the method for processing data as defined in any one of the designs in the third aspect.

In a sixth aspect, a non-transitory computer-readable storage medium storing instructions is provided. The instructions, when executed on a computer, cause the computer to perform the method for processing data as defined in any one of the designs in the first aspect, the second aspect, or the third aspect.

In a seventh aspect, a computer program product containing instructions is provided. The computer program product, when running on a computer, causes the computer to perform the method for processing data as defined in any one of the designs in the first aspect, the second aspect, or the third aspect.

In summary, the system for processing data provided in the present disclosure includes a first relay node, at least one request node, and at least one processing node. Each request node can send the data processing request to any one of the processing nodes via the first relay node, so as to make the processing node to execute the data processing operation requested by the data processing request and transmit the result of the data processing operation to the request node. It can be seen that, based on the system for processing data provided in the present disclosure, the present disclosure provides a new method for processing data, and enriches the methods for processing data.

In addition, the system for processing data and the method for processing data provided in the present disclosure can decouple the request node from the processing node, so that the number of both the request nodes and the processing nodes can be expanded. Moreover, in the case that the number of at least one of the request nodes and the processing nodes is expanded, the performance of the system for processing data will be changed. Therefore, the present disclosure can support the flexible adjustment of the performance of the system for processing data.

### BRIEF DESCRIPTION OF THE DRAWINGS

FIG. 1 is a schematic structural diagram of a system for processing data according to an embodiment of the present disclosure;

FIG. 2 is a schematic structural diagram of another system for processing data according to an embodiment of the present disclosure;

FIG. 3 is a flowchart of a method for processing data according to an embodiment of the present disclosure;

FIG. 4 is a schematic diagram illustrating a relationship between a time unit and a time period according to an embodiment of the present disclosure;

FIG. 5 is a schematic diagram illustrating another relationship between time unit and time period according to an embodiment of the present disclosure;

FIG. 6 is a schematic diagram of unit division for a target processing node some embodiments of the present disclosure;

FIG. 7 is a flowchart of another method for processing data according to an embodiment of the present disclosure;

FIG. 8 is a flowchart of another method for processing data according to an embodiment of the present disclosure;

FIG. 9 is a flowchart of another method for processing data according to an embodiment of the present disclosure;

FIG. 10 is a schematic diagram illustrating a relationship between multiple threads and multiple data processing requests according to an embodiment of the present disclosure;

FIG. 11 is a schematic structural diagram of an apparatus for processing data according to an embodiment of the present disclosure;

FIG. 12 is a schematic structural diagram of another apparatus for processing data according to an embodiment of the present disclosure;

FIG. 13 is a schematic structural diagram of another apparatus for processing data according to an embodiment of the present disclosure;

FIG. 14 is a schematic structural diagram of another apparatus for processing data according to an embodiment of the present disclosure;

FIG. 15 is a schematic structural diagram of another apparatus for processing data according to an embodiment of the present disclosure; and

FIG. 16 is a schematic structural diagram of another apparatus for processing data according to an embodiment of the present disclosure.

### DETAILED DESCRIPTION

For clearer descriptions of the principle, technical solutions, and advantages of the present disclosure, embodiments of the present disclosure are further described in detail below with reference to the accompanying drawings.

Data processing is an indispensable step in various fields.

For example, in the Internet of Things (IoT) domain, multiple IoT devices use data in different formats, and it is necessary to standardize these different formats of data. For example, the different formats mentioned above include javascript object notation (JSON) format which is a lightweight data-interchange format, test expression format, binary format, etc. The data in different formats may use the same or different communication protocols, such as transmission control protocol (TCP), message queuing telemetry transport (MQTT) protocol, user datagram protocol (UDP), constrained application protocol (CoAP), etc.

For another example, in the communication field, a communication device needs to process received request data sent by another communication device, obtain response data of the request data, and feed back the response data to the another communication device. Exemplarily, in the case that the request data is authentication data, the response data of the request data is an authentication result of the authentication data.

In the related art, one device for processing data is used to receive the data to be processed and carry out the processing of the data. However, current methods for processing data are simplistic. Moreover, in the case that it is necessary to process a large volume of data, the throughput of one device for processing data is limited. Using one device for processing data to handle massive amounts of data is inefficient and can lead to device failure. Moreover, once a device for processing data leaves the factory, the hardware thereof is difficult to change, resulting in fixed processing capabilities of the device for processing data. It would be challenging to enhance the performance of the device for processing data.

Based on this, the embodiments of the present disclosure provide a system for processing data, which is capable of processing data. Moreover, the method used by the system for processing data for data processing is different from the method used by the single device for processing data mentioned above for data processing, enriching the methods for processing data. In addition, the system for processing data has a higher throughput, supports the processing of massive amounts of data, and is not prone to failure. Moreover, during the use of the system for processing data, the processing capabilities thereof can be flexibly adjusted as needed.

Exemplarily, FIG. 1 is a schematic structural diagram of a system for processing data according to an embodiment of the present disclosure. As shown in FIG. 1, the system for processing data includes a first relay node 01, at least one request node 02, and at least one processing node 03. Both the request node 02 and the processing node 03 are in communication connection with the first relay node 01.

It should be noted that the number of the request node 02 in the system for processing data can be greater than or equal to 1, and the number of the processing node 03 can also be greater than or equal to 1. FIG. 1 shows an example where the number of both the request node 02 and the processing node 03 is 1. All nodes within the system for processing data, such as the first relay node, the request node and the processing node, can be a device, such as a server, a server cluster, or a part of a device, like an interface board within the device, which is not limited by embodiments of the present disclosure.

Optionally, as further shown in FIG. 1, the system for processing data further includes a second relay node 04, and both the request node 02 and the processing node 03 are in communication connection with the second relay node 04.

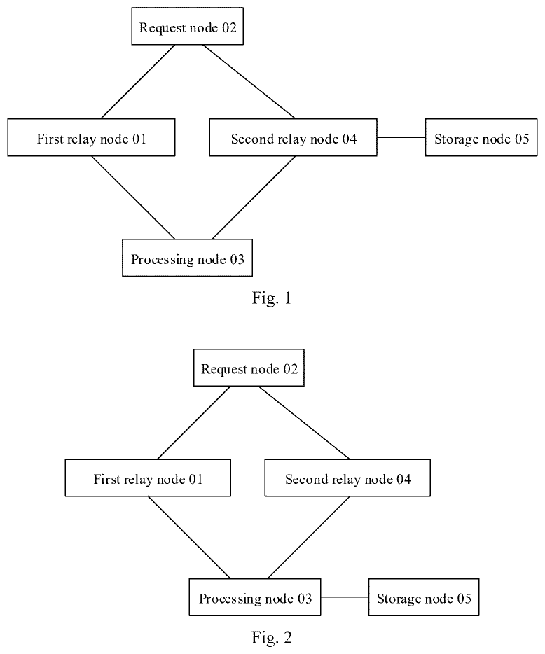

Optionally, the system for processing data further includes a storage node 05. The second relay node 04 is further in communication connection with the storage node 05. Alternatively, as shown in FIG. 2, the storage node 05 is not in communication connection with the second relay node 04 but is in communication connection with the processing node 03 instead.

The following will take a method for processing data provided by the embodiments of the present disclosure as an example to introduce functions of the system for processing data.

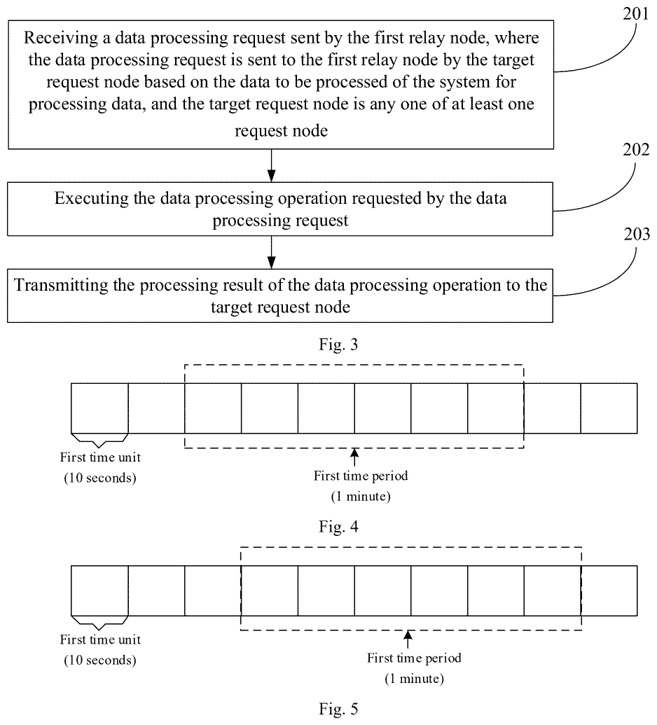

Exemplarily, FIG. 3 is a flowchart of a method for processing data according to an embodiment of the present disclosure. The method for processing data is applicable to a target processing node of the system for processing data provided by the embodiments of the present disclosure. The target processing node is any one of the at least one processing node in the system for processing data. The method for processing data performed by the other processing nodes except the target processing node in the at least one processing node can refer to the method for processing data performed by the target processing node.

As shown in FIG. 3, the method for processing data includes the following steps 201 to 203.

Step 201, receiving a data processing request sent by the first relay node, where the data processing request is sent to the first relay node by a target request node based on the data to be processed of the system for processing data, and the target request node is any one of at least one request node.

The target request node can acquire the data to be processed of the system for processing data and generates a data processing request based on the data to be processed. The data processing request is configured to request execution of a processing operation on the data to be processed. The processing operation is any kind of data processing operation, such as converting the format of the data, generating response data for the data, etc.

After obtaining the data processing request, the target request node can also send the data processing request to the first relay node, and the first relay node sends the data processing request to the target processing node.

Step 202, executing a data processing operation requested by the data processing request.

Step 203, transmitting a processing result of the data processing operation to the target request node.

After executing the data processing operation requested by the data processing request, the target processing node transmits the processing result of the data processing operation to the target request node, thereby enabling the target request node to obtain the processing result.

In summary, the system for processing data provided in the present disclosure includes a first relay node, at least one request node, and at least one processing node. Each request node can send the data processing request to any one of the processing nodes via the first relay node, so as to make the processing node to execute the data processing operation requested by the data processing request and transmit the result of the data processing operation to the request node. It can be seen that, based on the system for processing data provided in the present disclosure, the present disclosure provides a new method for processing data and enriches the methods for processing data.

In addition, the system for processing data and the method for processing data provided in the present disclosure can decouple the request node from the processing node, so that the number of both the request nodes and the processing nodes can be expanded. Moreover, in the case that the number of at least one of the request nodes and the processing nodes is expanded, the performance of the system for processing data will be changed. Therefore, the present disclosure can support the flexible adjustment of the performance of the system for processing data.

Further, in the aforementioned step 203, the target processing node can transmit the processing result to the target request node in any one of multiple methods.

For example, the target processing node may be in communication connection with the target request node, and in this case, the target processing node can directly send the processing result to the target request node.

For another example, in the case that the system for processing data further includes a second relay node, the target processing node can send the processing result to the second relay node and send a data processing response of the data processing request to the first relay node, and the data processing response is used to indicate that a processing result has been obtained. After receiving the data processing response, the first relay node may send the data processing response to the target request node. Subsequently, the target request node may acquire the processing result from the second relay node based on the data processing response. In this case, there is no need to transmit the processing result over the link among the target request node, the first relay node and the target processing node, thereby reducing the transmission load on the link, narrowing the bandwidth of the link, reducing the resource consumption of the system for processing data, and increasing the throughput of the system for processing data.

Optionally, the data processing request carries an identifier of a script corresponding to the data processing request; and the script corresponding to the data processing request is a script that needs to be run to execute the data processing operation requested by the data processing request. When executing step 202, the target processing node may use a processing unit, which has been created within the processing node and is used to run the script corresponding to the data processing request, to execute the data processing operation requested by the data processing request. It can be seen that in the present disclosure, the data processing request carries a script identifier, and thus it is not necessary to carry the script within the data processing request so that the data volume of the data processing request is lower, the transmission load on the link among the target request node, the first relay node, and the target processing node is reduced, the bandwidth of the link is lower, the resource consumption of the system for processing data is reduced, and the throughput of the system for processing data is increased.

Optionally, the data processing request may further carry metadata required for running the script corresponding to the data processing request. The processing unit runs the script corresponding to the data processing request based on the metadata. Alternatively, the data processing request may not carry the metadata, which is not limited by embodiments of the present disclosure.

Optionally, the data processing request may further carry the data to be processed. It should be understood that the data processing request may not carry the data to be processed, but instead carry an identifier of the data to be processed. In this case, the target request node may also transmit the data to be processed to the second relay node. Upon receiving the data processing request, the target processing node may acquire the data to be processed from the second relay node based on the identifier of the data to be processed carried by the data processing request and then process the data to be processed.

Further, the data processing request being sent by the first relay node includes: the data processing operations requested by different data processing requests are executed by the same processing unit within the target processing node, in response to the requesting of different data processing requests corresponding to the same script. Thus, requests of the same script use a same processing unit to execute data processing operations, thereby avoiding the creation of multiple identical processing units, reducing the load on the processing node for creating processing units, lowering the resource consumption of the system for processing data, and increasing the throughput of the system for processing data.

It should be understood that data processing operations requested by requests corresponding to the same script can also be executed by different processing units. Alternatively, the data processing operations requested by a portion of the different data processing requests corresponding to the same script are executed by the same processing unit, while the data processing operations requested by another portion of the different data processing requests corresponding to the same script are executed by a different processing unit.

Further, the target processing node may manage the number of the processing units within therein.

Exemplarily, the target processing node can determine a first number of the data processing requests received within a most recent first time period for many times. In the case that a growth rate of the first number is greater than a first probability threshold, the target processing node can increase the processing units therein, and the first probability threshold is greater than zero. In the case that the growth rate of the first number is less than a second probability threshold (the first number having a higher decrease rate), the target processing node can decrease the processing units therein, and the second probability threshold is less than zero.

It can be seen that the target processing node can appropriately increase or decrease the number of processing units within the target processing node based on the number of received data processing requests, so as to minimize power consumption while ensuring a processing speed and achieve reasonable utilization of the resources of the target processing node.

Optionally, before increasing (or decreasing) the number of processing units within the target processing node, the target processing node can determine the number of processing units to be increased (or decreased) based on the growth rate of the first number. Alternatively, the number of processing units increased (or decreased) by the target processing node each time is a fixed value.

Optionally, each time determining the first number of data processing requests received within the most recent first time period, the target processing node may also determine an auxiliary number of data processing requests corresponding to the same script received within the first time period. Before increasing (or decreasing) the processing units in the target processing node, the target processing node may determine whether to increase (or decrease) the processing units for running the same script based on the growth rate of the auxiliary number. For example, in the case that a growth rate of the auxiliary number is greater than a third probability threshold, the processing units within the target processing node for running the same script are increased, and the third probability threshold is greater than zero; and in the case that the growth rate of the auxiliary number is less than a fourth probability threshold (the auxiliary number having a higher decrease rate), the processing units within the target processing node for running the same script are decreased, and the fourth probability threshold is less than zero.

For another example, the target processing node can also determine a second number of data processing requests corresponding to the same script received within a most recent second time period for many times. In the case that the growth rate of the second number is greater than a third probability threshold, the processing units for running the same script in the target processing node are increased. In the case that the growth rate of the second number is less than a fourth probability threshold (the second number having a higher decrease rate), the processing units for running the same script in the target processing node are decreased.

It can be seen that in the embodiments of the present disclosure, the target processing node can appropriately increase or decrease the number of processing units for running the script based on the number of requests received corresponding to the same script, so as to minimize the power consumption of the target processing node while ensuring data processing efficiency.

Optionally, the target processing node may use a sliding time window algorithm to determine the aforementioned first number, second number, and auxiliary number.

Exemplarily, taking the first number as an example, the target processing node may conduct first statistics on the number of data processing requests received within each first time unit, and the first time period includes multiple consecutive first time units. In the case that the target processing node determines the first number using the sliding time window algorithm, the target processing node can determine the first number based on the first statistics.

As shown in FIG. 4, assuming that the first time unit is 10 seconds and the first time period is 1 minute (including 6 first time units), then the target processing node can conduct statistics on the number of data processing requests received every 10 seconds. Each time the first number is determined, the target processing node can acquire the number obtained by statistics from the most recent 6 first time units and determine a sum of these numbers as the first number. The most recent 6 first time units determined by the target processing node when determining the first number for many times change over time. For example, the most recent 6 first time units determined by the target processing node when determining the first number for the first time are as shown in FIG. 4, and the most recent 6 first time units determined by the target processing node when determining the first number for the second time are as shown in FIG. 5, with the time of the second determination of the first number and the time of the first determination of the first number differing by one first time unit (10 seconds).

Similarly, for the auxiliary number, the method for processing data further includes: the target processing node conducts second statistics on a number of data processing requests corresponding to the same script received within each first time unit, with the first time period including multiple consecutive first time units. In the case that the target processing node determines the auxiliary number using the sliding time window algorithm, the target processing node can determine the auxiliary number based on the second statistics. For the second number, the method for processing data further includes: the target processing node conducts third statistics on the number of data processing requests corresponding to the same script received within each second time unit, with the second time period including multiple consecutive second time units; and the target processing node. In the case that the target processing node determines the second number using the sliding time window algorithm, the target processing node can determine the second number based on the third statistics.

Further, as can be seen from the above contents, the target processing node executes data processing operations using the processing units that have been created. The process of creating processing units by the target processing node may be referred to as the process of increasing processing units by the target processing node. In the case that the target processing node increases m processing units, the target processing node needs to execute x script acquisition operations to obtain n scripts for the m processing units to run (where each processing unit is configured to run one script), and then create the m processing units based on the n scripts, where m≥x≥n≥1.

Exemplarily, one script acquisition operation corresponds to one of n scripts. The script acquisition operation is configured to: acquire the corresponding script from the memory, in the case that a corresponding script is stored in a memory of the target processing unit; and send an acquisition request for the corresponding script to the second relay node and receive a corresponding script sent by the second relay node based on the acquisition request, in the case that the corresponding script is not stored in the memory.

On one hand, in the case that the second relay node is in communication connection with a storage node, upon receiving the acquisition request, the second relay node first checks whether the script for acquisition by the acquisition request is stored locally. In the case that the script is not stored locally, the second relay node may acquire the script from the connected storage node, store the script locally at the second relay node, and send the script to the target processing node.

On the other hand, in the case that the second relay node is not in communication connection with a storage node but the storage node is in communication connection with the target processing node, when a certain script requested by the acquisition request is not stored locally at the second relay node, the second relay node may also send an acquisition response to the target processing node indicating that the script is not stored. In this case, the target processing node may send the acquisition request to the storage node and receive the script sent by the storage node. Afterwards, the target processing node may resend the script to the second relay node, such that the second relay node stores the script.

Optionally, a memory of the target processing node and the second relay node may both store information (such as scripts) in a caching manner. As such, the scripts stored in the memory or the second relay node all have a validity period, which reduces over time. When the validity period reduces to zero, the script will be released, thereby preventing the script from occupying the storage position and reducing the load on the target processing node or the second relay node. In addition, in the case that the script is read, the validity period of the script will be reset to an initial value (greater than zero).

The storage node mentioned above may store information (such as scripts) in a non-caching manner (e.g., a persistent storage manner), which is not limited by embodiments of the present disclosure. The storage node may be a relational database management system node (such as MySQL).

Optionally, m>x=n. In the case that m>n, there are multiple processing units, which are configured to run the same script, among the m processing units. Since x=n, the number of times that the target processing node executes script acquisition operations are equal to the number n of scripts that m processing units are configured to run. Moreover, for the multiple processing units that are configured to run the same script, the target processing node only needs to execute the script acquisition operation once for the same script, without executing the script acquisition operation multiple times. This approach avoids the issue of repeatedly acquiring the same script on the memory, the second relay node, or the storage node, which could affect the performance of the memory and the second relay node.

In the case that the second relay node stores information in a caching manner, a phenomenon, in which the same script is repeatedly acquired on the second relay node but the script is not cached on the second relay node, and thus the script is repeatedly acquired on the storage node, is referred to as cache penetration. The cache penetration will cause a thundering herd that affects the performance of the entire system for processing data. Adopting the solutions provided in the embodiments of the present disclosure can prevent the cache penetration, avoid the thundering herd, and ensure the performance of the entire system for processing data. In addition, it can prevent the second relay node or the target processing node from repeatedly caching the same script on the second relay node, thereby reducing the load on the second relay node or the target processing node.

Further, the target processing node can also conduct statistics on the frequency at which each script stored in the memory and the second relay node is run (the frequency at which the script is run by the processing unit). In the case that the first script stored in the second relay node is run at a frequency greater than a first frequency threshold, the target processing node may move the first script from the second relay node to the memory. In the case that the second script stored in the memory is run at a frequency greater than a second frequency threshold and less than or equal to the first frequency threshold (the first frequency threshold greater than or equal to zero), the target processing node moves the second script from the memory to the second relay node.

It can be seen that for scripts stored in the memory and the second relay node, the target processing node adjusts the storage position of the script based on the running frequency of the script, so that the first script with a higher running frequency is stored in memory and the efficiency of the target processing node reading the first script is enhanced. In addition, the second script with a lower running frequency can be made to be stored on the second relay node, to prevent the second script from occupying the memory of the target processing node.

It could be understood that when the memory and the second relay node store scripts in a caching manner, the scripts have a validity period, and when the target processing node transfers the scripts between the memory and the second relay node, the validity period of the scripts would be reset.

Optionally, before executing the data processing operation requested by the data processing request, the target processing node also needs to determine (such as create or find) the processing unit for executing the data processing operation requested by the data processing request. Exemplarily, upon receiving multiple data processing requests sent by the first relay node, the target processing node can determine the processing units in the processing node that are respectively configured to run the scripts corresponding to the multiple data processing requests, by using multiple threads in parallel and according to the multiple data processing requests. Thus, determining processing units with multiple threads in parallel can enhance efficiency, and further improve the system's throughput, thereby enabling the system for processing data to support the processing of massive amounts of data.

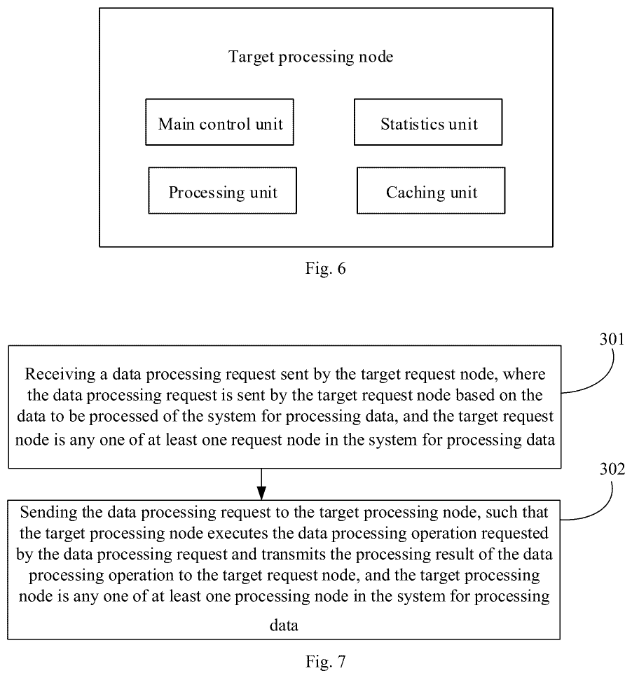

Exemplarily, based on the functions of the target processing node provided in the embodiments of the present disclosure, the target processing node may be divided into various units. For example, as shown in FIG. 6, the target processing node includes a main control unit, a statistics unit, a processing unit and a caching unit.

The statistics unit is configured to conduct statistics on the aforementioned first number, second number, auxiliary number, and frequency at which scripts are run.

The processing unit is configured to run scripts to execute data processing operations corresponding to data processing requests and obtain the processing results.

The caching unit is configured to adjust the storage position of scripts on the memory and the second relay node based on the frequency at which the scripts are run. The caching unit may be further configured to execute the aforementioned script acquisition operations.

In the method used for the target processing unit, operations other than those executed by the statistics unit, the processing unit, and the caching unit may be all executed by the main control unit. For example, the main control unit is configured to receive data processing requests sent by the first relay node; determine the processing unit for executing the data processing operation requested by the data processing request; send the processing result to the second relay node; send the data processing response to the first relay node; and adjust the number of processing units based on the statistical result from the statistics unit.

FIG. 7 is a flowchart of another method for processing data according to an embodiment of the present disclosure. The method for processing data is applicable to the first relay node of the system for processing data provided in the embodiments of the present disclosure. As shown in FIG. 7, the method for processing data includes the following steps 301 and 302.

Step 301, receiving a data processing request sent by a target request node, where the data processing request is sent by the target request node based on the data to be processed of the system for processing data and the target request node is any one of at least one request node in the system for processing data.

Step 302, sending the data processing request to a target processing node, so as to facilitate the target processing node to execute a data processing operation requested by the data processing request and transmit a processing result of the data processing operation to the target request node, where the target processing node is any one of at least one processing node in the system for processing data.

In summary, the system for processing data provided in the present disclosure includes a first relay node, at least one request node, and at least one processing node. Each request node can send the data processing request to any one of the processing nodes via the first relay node, so as to make the processing node to execute the data processing operation requested by the data processing request and transmit the result of the data processing operation to the request node. It can be seen that, based on the system for processing data provided in the present disclosure, the present disclosure provides a new method for processing data, and enriches the methods for processing data.

In addition, the system for processing data and the method for processing data provided in the present disclosure can decouple the request node from the processing node, so that the number of both the request nodes and the processing nodes can be expanded. Moreover, in the case that the number of at least one of the request nodes and the processing nodes is expanded, the performance of the system for processing data will be changed. Therefore, the present disclosure can support the flexible adjustment of the performance of the system for processing data.

Optionally, the system for processing data further includes a second relay node, and the target processing node is configured to send the processing results to the second relay node. In this case, the method for processing data further includes: the first relay node receives a data processing response of the data processing request sent by the target processing node, and the data processing response is used to indicate that the processing result has been obtained; subsequently, the first relay node sends the data processing response to the target request node, such that the target request node acquires the processing result from the second relay node based on the data processing response. In this case, there is no need to transmit the processing result over the link among the target request node, the first relay node and the target processing node, thereby reducing the transmission load on the link, narrowing the bandwidth of the link, reducing the resource consumption of the system for processing data, and increasing the throughput of the system for processing data.

In the embodiments of the present disclosure, that the target processing node transmits the processing result to the target request node via the second relay node is taken as an example. Optionally, the target processing node may also directly transmit the processing result to the target request node. In this case, it is not necessary for the first relay node to receive the data processing response or send the data processing response to the target request node. It is also not necessary for the second relay node to store the aforementioned processing result.

Optionally, after receiving a data processing request, the first relay node may also parse the data processing request to obtain information carried by the data processing request, such as the identifier of the script corresponding to the data processing request, etc. The first relay node may also package the information into a message structure object (also referred to as a request msg) in a certain format to update the data processing request. Subsequently, the first relay node may send the updated data processing request to the target processing node. Thus, it enables all data processing requests received by the target processing node to adopt the structure of the message structure object, facilitating the parsing and processing of the data processing requests by the target processing node.

In the case that the data processing request carries the identifier of the script corresponding to the data processing request, there is no need to carry the script within the data processing request, which results that the data processing request has a lower volume of data, the transmission load on the link among the target request node, the first relay node, and the target processing node is reduced, the bandwidth of the links is lowered, the resource consumption of the system for processing data is reduced, and the throughput of the system for processing data is increased.

Optionally, the data processing request may further carry the metadata required for running the script corresponding to the data processing request. Alternatively, the data processing request may also not carry the metadata, which is not limited by embodiments of the present disclosure.

Optionally, the data processing request may further carry the data to be processed. It should be understood that the data processing request may also not carry the data to be processed, but carry an identifier of the data to be processed instead. In this case, the target request node may also transmit the data to be processed to the second relay node. Upon receiving the data processing request, the target processing node may acquire the data to be processed from the second relay node based on the identifier of the data to be processed carried by the data processing request, and then process the data to be processed.

Optionally, in step 302, upon receiving multiple data processing requests sent by the target request node, the first relay node may send (one or more) first data processing requests in the multiple data processing requests to the target processing node; upon receiving the data processing response of the first data processing request, the first relay node sends (one or more) second data processing requests in the multiple data processing requests to the target processing node. It can be seen that the first relay node may send a group of data processing requests to the target processing node at a time, and upon receiving the data processing response of the group of data processing requests sent by the target processing node, the first relay node sends the next group of data processing requests to the target processing node.

Thus, it prevents the influx of a large volume of data processing requests to the processing node, which could lead to the failure of the processing node, thus achieving a peak shaving effect for data processing requests. Moreover, the multiple data processing requests to be sent to the target processing node may be buffered at the first relay node, such that the data processing system can handle more data and thus the overall throughput of the system for processing data is increased.

Optionally, the first relay node may maintain multiple queues. After receiving a data processing request sent by the target request node, the first relay node may add the data processing request to a first queue therein. In this case, when sending the data processing request to the target processing node, the first relay node may send the data processing request in the first queue to the target processing node. Upon receiving a data processing response of the data processing request sent by the target processing node, the first relay node may add the data processing response to a second queue among the multiple queues. In this case, when sending the data processing response to the target request node, the first relay node may send the data processing response from the second queue to the target request node.

By caching the received data processing requests and data processing responses through queues, the first relay node may maintain the orderliness of these data processing requests and data processing responses. In addition, the data processing requests and the data processing responses added to the queues are generally not deleted until the queues are full, thus achieving the persistence of the data processing requests and the data processing responses on the first relay node.

Optionally, both the first queue and second queue are established through a subscription manner. Exemplarily, the target processing node may send the identifier of the first queue to the first relay node to subscribe to the first queue with the first relay node. Subsequently, in the case that the first relay node receives a data processing request that needs to be sent to the target processing node, the first relay node may add the data processing request to the first queue and then send the data processing request in the first queue to the target processing node. Similarly, the target request node may send the identifier of the second queue to the first relay node to subscribe to the second queue with the first relay node. Subsequently, in the case that the first relay node receives a data processing response that needs to be sent to the target request node, the first relay node may add the data processing response to the second queue and then send the data processing response in the second queue to the target request node.

The number of first queue and second queue can be one or multiple, which is not limited by embodiments of the present disclosure. Exemplarily, the first relay node may maintain multiple groups of queues, which include one group of first queues and one group of second queues, and each group of queues includes at least one queue. When subscribing to the first queue, the target processing node may send identifiers of each queue in the one group of first queues to the first relay node or send the identifier of the one group of first queues. When subscribing to the second queue, the target request node may send the identifiers of each queue in the one group of second queues to the first relay node or send the identifier of the one group of second queues. The identifier of one group of queues is referred to as one topic.

Further, in the case that multiple first queues exist, the target request node may specify which first queue a data processing request enters (for example, the data processing request carries the identifier of the first queue it needs to enter). Alternatively, the target request node may also not specify which first queue the data processing request enters, leaving it up to the first relay node to determine (for example, determining in a random manner or based on the length of each first queue) which first queue the data processing request enters. Similarly, in the case that multiple second queues exist, the target processing node may also specify which second queue a data processing response enters (for example, the data processing response carries the identifier of the second queue it needs to enter). Alternatively, the target processing node may also not specify which second queue the data processing response enters, leaving it up to the first relay node to determine (for example, determining in a random manner or based on the length of each second queue) which second queue the data processing response enters.

In the case that the first relay node maintains the aforementioned multiple queues, the first relay node may be a Kafka (an open-source stream processing platform) node or a NATS (a fire-and-forget messaging system) node. In the case that the second relay node stores information in a caching manner, the second relay node may be a remote dictionary server (Redis) node.

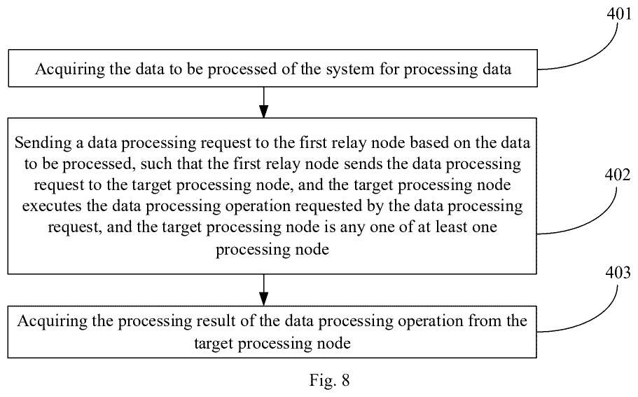

FIG. 8 is a flowchart of another method for processing data according to an embodiment of the present disclosure. The method for processing data is applicable to the target request node of the system for processing data provided in the embodiments of the present disclosure. The target request node is any one of at least one request node in the system for processing data.

Step 401, acquiring data to be processed of the system for processing data.

The request node may be in communication connection with devices outside the system for processing data, and may receive the data to be processed sent by devices outside the system for processing data.

For example, the devices outside the system for processing data include multiple IoT devices, and at least some of the IoT devices among the multiple IoT devices use different data formats. Therefore, IoT devices need to send the data they adopted to the data processing system for data format conversion. In this case, IoT devices send the data they adopted to the target request node, enabling the target request node to acquire the data to be processed, which is then processed in subsequent steps.

It should be understood that the data to be processed may not be data sent by devices outside the system for processing data, for example, the data to be processed is data entered into the target request node by users, which is not limited by embodiments of the present disclosure.

Step 402, sending a data processing request to the first relay node based on the data to be processed, such that the first relay node sends the data processing request to the target processing node, and the target processing node executes the data processing operation requested by the data processing request. The target processing node is any one of at least one processing node.

The target processing node encapsulates the data processing request based on the data to be processed and then sends the data processing request to the first relay node.

Step 403, acquiring the processing result of the data processing operation from the target processing node.

The data request node, upon acquiring the processing result, transmits the processing result to other devices, or further processes the processing result, etc. The embodiments of the present disclosure do not limit the actions of the data request node after acquiring the processing result.

In summary, the system for processing data provided in the present disclosure includes a first relay node, at least one request node, and at least one processing node. Each request node can send the data processing request to any one of the processing nodes via the first relay node, so as to make the processing node to execute the data processing operation requested by the data processing request and transmit the result of the data processing operation to the request node. It can be seen that, based on the system for processing data provided in the present disclosure, the present disclosure provides a new method for processing data, and enriches the methods for processing data.

In addition, the system for processing data and the method for processing data provided in the present disclosure can decouple the request node from the processing node, so that the number of both the request nodes and the processing nodes can be expanded. Moreover, in the case that the number of at least one of the request nodes and the processing nodes is expanded, the performance of the system for processing data changes will be changed. Therefore, the present disclosure can support the flexible adjustment of the performance of the system for processing data.

Optionally, the system for processing data further includes a second relay node. The target processing node is configured to send the processing result to the second relay node and to send a data processing response of the data processing request to the first relay node, and the data processing response is used to indicate that the processing result has been obtained. In Step 403, the target request node, upon receiving the data processing response sent by the first transit node, acquires the processing result from the second relay node based on the data processing response. In this case, there is no need to transmit the processing result over the link among the target request node, the first relay node, and the target processing node, thereby reducing the transmission load on the link, lowering the bandwidth of the link, reducing the resource consumption of the system for processing data, and increasing the throughput of the system for processing data.

In the embodiments of the present disclosure, an example is provided where the target processing node transmits the processing result to the target request node via the second relay node. Optionally, the target processing node is in communication connection with the target request node, allowing the target request node to directly receive the processing result sent by the target processing node. The embodiments of the present disclosure do not impose any limitations on this aspect.

Optionally, the aforementioned data processing request carries an identifier of the script corresponding to the data processing request; the script corresponding to the data processing request is the script that needs to be run to execute the data processing operation requested by the data processing request. The target processing node uses a processing unit, which has been created within the processing node to run the script corresponding to the data processing request, to execute the data processing operation requested by the data processing request. It can be seen that in the present disclosure, the data processing request carries a script identifier, and thus it is not necessary to carry the script within the data processing request so that the data volume of the data processing request is lower, the transmission load on the link among the target request node, the first relay node, and the target processing node is reduced, the bandwidth of the link is lower, the resource consumption of the system for processing data is reduced, and the throughput of the system for processing data is increased.

Optionally, the data processing request further carries the metadata required for running the script corresponding to the data processing request. The processing unit runs the script corresponding to the data processing request based on the metadata. Alternatively, the data processing request does not carry the metadata, which is not limited by embodiments of the present disclosure.

Optionally, the data processing request further carries the data to be processed. It should be understood that the data processing request may not carry the data to be processed, but instead carry an identifier of the data to be processed. In this case, the target request node may also transmit the data to be processed to the second relay node. Upon receiving the data processing request, the target processing node, based on the identifier of the data to be processed carried by the data processing request, acquires the data to be processed from the second relay node, and then processes the data to be processed.

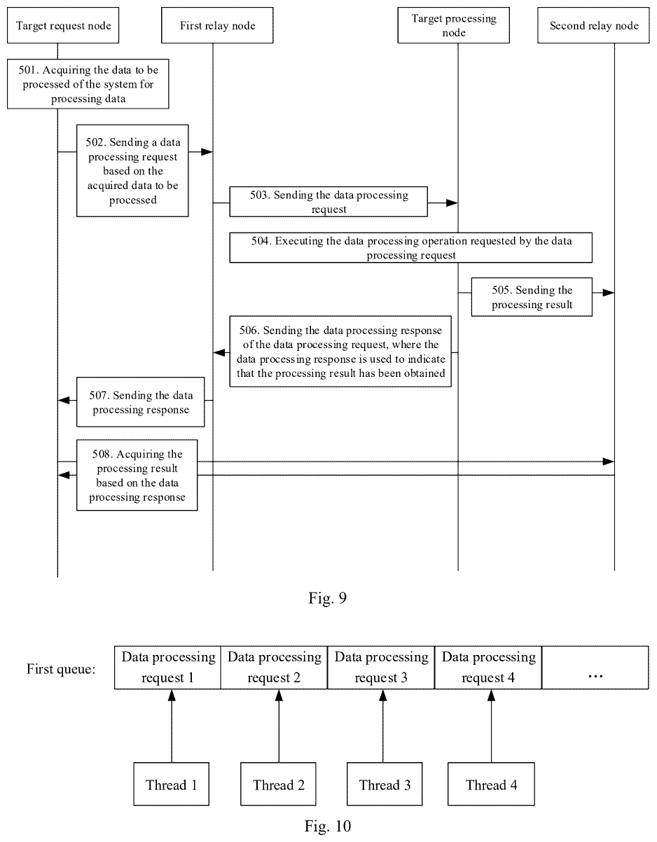

FIG. 9 illustrates another method for processing data according to an embodiment of the present disclosure. The method for processing data is applicable to the system for processing data provided in the embodiments of the present disclosure. As shown in FIG. 9, the method for processing data includes the following steps:

In step 501, a target request node acquires data to be processed of a system for processing data.

Step 501 may refer to the relevant explanations in the embodiment shown in FIG. 8 (such as step 401, etc.), and the embodiments of the present disclosure will not be repeated here.

The data to be processed acquired by the target request node may be data in a format to be converted, or, the data to be processed may be for which response data is to be obtained.

Exemplarily, the data to be processed may be uplink data from IoT devices outside the system for processing data intended to be sent to an IoT platform. In this case, the data processing system needs to convert the format of the data to be processed to the format used by the IoT platform.

For another example, the data to be processed may be downlink data from an IoT platform intended to be sent to IoT devices. In this case, the system for processing data needs to convert the format of the data to be processed to the format used by the IoT devices.

Optionally, in the case that the data to be processed is related to an IoT platform, at least one node within the system for processing data provided in the embodiments of the present disclosure may be integrated with the IoT platform, or the entire system for processing data may be independently from the IoT platform. The IoT platform is a platform based on cloud computing and is capable of providing multi-protocol/multi-type device access, device management, device monitoring, unified device model (meaning the standardization of data formats of different device models), device shadows, and data processing and analysis.

For still another example, the data to be processed is authentication data, and the system for processing data needs to process the authentication data to obtain an authentication result of the authentication data.

In step 502, the target request node sends a data processing request to a first relay node based on acquired data to be processed.

Step 502 may refer to the relevant explanations in the embodiment shown in FIG. 8 (such as step 402, etc.), and the embodiments of the present disclosure will not be repeated here.

The target processing node may encapsulate the data processing request based on the data to be processed and then send the data processing request to the first relay node. Exemplarily, the data processing request (such as the load of the data processing request) may carry the data to be processed (msg), an identifier of the data processing request (request ID), an identifier (ID) of the script corresponding to the data processing request, and the metadata required to run the script.

In step 503, the first relay node sends the data processing request to a target processing node.

Step 503 may refer to the relevant explanations in the embodiment shown in FIG. 7 (such as step 302, etc.), and the embodiments of the present disclosure will not be repeated here.

Exemplarily, the first relay node maintains multiple queues. Before step 503, the target processing node may send a subscription request to the first relay node, and the subscription request carries an identifier of one queue group (including at least one first queue) among the multiple queues. Upon receiving the data processing request sent by the target request node in step 502, the first relay node may add the data processing request to one first queue in the queue group based on the identifier of the queue group. Moreover, in step 503, the first relay node may send the data processing request from the one queue group to the target processing node.

When sending the data processing request from one first queue to the target processing node, the first relay node may send one group of data processing requests in the first queue to the target processing node at one time. Upon receiving the data processing response sent by the target processing node for the one group of data processing requests, the first relay node may continue to send a next group of data processing requests in the first queue to the target processing node. Each group of data processing requests includes at least one consecutive data processing request.

In step 504, the target processing node executes a data processing operation requested by the data processing request.

Step 504 may refer to the relevant explanations in the embodiment shown in FIG. 3 (such as step 202, etc.), and the embodiments of the present disclosure will not be repeated here.

The target processing node will simultaneously receive one or more data processing requests. For one data processing request received by the target processing node, the target processing node will first parse the data processing request to determine the data to be processed, the identifier of the data processing request, the identifier of the script corresponding to the data processing request, and the metadata required to run the script, which are carried by the data processing request. Subsequently, the target processing node needs to determine a processing unit in the target processing node for running the script, based on the identifier of the script corresponding to the data processing request. Finally, the target processing node may use the processing unit to execute the data processing operation requested by the data processing request, based on the metadata.

It should be noted that a processing unit is a unit in the target processing node that has a processing function, and the processing unit can be created and destroyed by the target processing node. When executing the data processing operation requested by one data processing request, the processing unit will run the script corresponding to the data processing request, construct the environment for executing the data processing operation, and then execute the data processing operation, so as to process the data to be processed in the data processing request.

The target processing node may or may not have already created the processing unit. In the case that the processing unit has not been created in the target processing node, the target processing node may create the processing unit.

Upon parsing and obtaining the identifier of the script and determining that the processing unit has not been created in the target processing node, the target processing node may create the processing unit immediately. Alternatively, when increasing the processing units by using the solution of increasing processing units in the embodiment shown in FIG. 3, the target processing node may create the processing unit for running the script, which is not limited by embodiments of the present disclosure.

Optionally, upon simultaneously receiving multiple data processing requests, the target processing node may use multiple threads in parallel to parse the data processing requests and determine the processing units for running the scripts corresponding to the data processing requests. Exemplarily, as shown in FIG. 10, assuming that the first relay node sends data processing requests 1, 2, 3, and 4 in the first queue to the target processing node simultaneously. The target processing node may use threads 1, 2, 3, and 4 to parse the data processing requests 1, 2, 3, and 4 in one-to-one correspondence and determine the respective processing units for running the scripts corresponding to the data processing requests 1, 2, 3, and 4, where threads 1, 2, 3, and 4 work in parallel.

In step 505, the target processing node sends a processing result to the second relay node.

Step 505 may refer to the relevant explanations in the embodiment shown in FIG. 3, and the embodiments of the present disclosure will not be repeated here.

Upon obtaining the processing result of the data processing operation requested by one data processing request, the target processing node may send the processing result to the second relay node. Exemplarily, the processing result may carry a processed data to be processed and an identifier of the data processing request, and the identifier of the data processing request is used to indicate that the processing result is the processing result of the data processing request.

Upon receiving the processing result, the second relay node may store the processing result, so as to facilitates reading of the processing result by a subsequent target request node.

In step 506, the target processing node sends a data processing response of the data processing request to the first relay node, and the data processing response is used to indicate that the processing result has been obtained.

Step 506 may refer to the relevant explanations in the embodiment shown in FIG. 3, and the embodiments of the present disclosure will not be repeated here.

Upon obtaining the processing result, the target processing node may further send a data processing response to the first relay node which does not carry a processing result (such as a processed data to be processed) but which may carry an identifier of the data processing request, as well as an indication for indicating that the processing result has been obtained.

In step 507, the first relay node sends the data processing response to the target request node.

Exemplarily, the first relay node maintains multiple queues. Before step 507, the target request node may send a subscription request to the first relay node, and the subscription request carries an identifier of one queue group (including at least one second queue) among the multiple queues. Upon receiving the data processing response sent by the target processing node in step 506, the first relay node may add the data processing response to one second queue in the queue group based on the identifier of the queue group. Moreover, in step 507, the first relay node may send the data processing response from the one queue group to the target request node.

In step 508, the target request node acquires the processing result from the second relay node based on the data processing response.

Upon receiving the data processing response, the target request node may acquire the processing result carrying the identifier of the data processing request from the second relay node based on the identifier of the data processing request in the data processing response.

Exemplarily, the target request node may send a read request to the second relay node based on the data processing response, and the read request carries an identifier of the data processing request. Upon receiving the read request, the second relay node may search for the processing result carrying the identifier of the data processing request and send the processing result to the target request node.

In summary, the system for processing data provided in the present disclosure includes a first relay node, at least one request node, and at least one processing node. Each request node can send the data processing request to any one of the processing nodes via the first relay node, so as to make the processing node to execute the data processing operation requested by the data processing request and transmit the result of the data processing operation to the request node. It can be seen that, based on the system for processing data provided in the present disclosure, the present disclosure provides a new method for processing data, and enriches the methods for processing data.

In addition, the system for processing data and the method for processing data provided in the present disclosure can decouple the request node from the processing node, so that the number of both the request nodes and the processing nodes can be expanded. Moreover, in the case that the number of at least one of the request nodes and the processing nodes is expanded, the performance of the system for processing data changes will be changed. Therefore, the present disclosure can support the flexible adjustment of the performance of the system for processing data.

In the embodiment shown in FIG. 9, the target processing node may also manage the number of processing units within the target processing node. For example, referring to the embodiment shown in FIG. 3, the number of processing units is increased or decreased based on the statistics of the first number, the second number, and the auxiliary number. The target processing node also, with reference to the embodiment shown in FIG. 3, moves scripts between the memory and the second relay node.

It should be noted that the solutions shown in FIGS. 3, 7, 8, and 9 may be combined with each other, and the explanations and effects of similar solutions may refer to each other. The embodiments of the present disclosure will not be repeated here.

As can be seen from the embodiments of the method for transmitting data, the target request node is configured to acquire the data to be processed of the system for processing data and send a data processing request to the first relay node based on the data to be processed.

The first relay node is configured to send the data processing request to the target processing node.

The target processing node is configured to execute the data processing operation requested by the data processing request and transmit the processing result of the data processing operation to the target request node.

The target request node is configured to acquire the processing result of the data processing operation from the target processing node.

Optionally, the system for processing data may further include a second relay node, and the target processing node is configured to send the processing result to the second relay node and send a data processing response of the data processing request to the first relay node.

The first relay node is further configured to send the data processing response to the target request node.

The target request node is configured to acquire the processing result from the second relay node based on the data processing response, and the data processing response is used to indicate that the processing result has been obtained.

Optionally, the data processing request carries an identifier of a script corresponding to the data processing request; and the script corresponding to the data processing request is a script that needs to be run to execute the data processing operation requested by the data processing request.

The target processing node is configured to:
execute the data processing operation by using a processing unit which has already been created within the processing node to run the script corresponding to the data processing request.

Optionally, the data processing request sent by the first relay node includes different data processing requests corresponding to the same script; and the data processing operations requested by the different data processing requests are executed by the same processing unit.

Optionally, the target processing node is further configured to:
determine a first number of the data processing requests received within a most recent first time period for many times;
increase the processing units in the target processing node in a case that a growth rate of the first number is greater than a first probability threshold, where the first probability threshold is greater than zero; and
decrease the processing units in the target processing node in a case that the growth rate of the first number is less than a second probability threshold, where the second probability threshold is less than zero.

Optionally, the target processing node is further configured to:
determining a second number of the data processing requests corresponding to the same script received within a most recent second time period for many times;
increase processing units for running the same script in the target processing node in a case that a growth rate of the second number is greater than a third probability threshold, where the third probability threshold is greater than zero; and
decrease processing units for running the same script in the target processing node in a case that the growth rate of the second number is less than a fourth probability threshold, where the fourth probability threshold is less than zero.

Optionally, the system for processing data further includes a second relay node, and the target processing node is configured to:
execute x script acquisition operations to obtain n scripts for the m processing units to run, in a case that m processing units in the processing node are increased, where m≥x≥n≥1, one said script acquisition operation corresponds to one script out of the n scripts, and the script acquisition operation is configured to: acquire a corresponding script from the memory, in a case that a corresponding script is stored in a memory of the target processing unit; and send an acquisition request for a corresponding script to the second relay node and receive the corresponding script sent by the second relay node based on the acquisition request, in a case that the corresponding script is not stored in the memory; and
create the m processing units based on the n scripts.

Optionally, m>x=n.

Optionally, the target processing node is further configured to:
conduct statistics on frequency at which each script stored in the memory and the second relay node is run;
move the first script from the second relay node to the memory, in a cast that a first script stored in the second relay node is run at a frequency greater than a first frequency threshold; and
move the second script from the memory to the second relay node, in a cast that a second script stored in the memory is run at a frequency greater than a second frequency threshold and less than or equal to the first frequency threshold.

Optionally, the target processing node is further configured to, upon receiving multiple data processing requests sent by the first relay node determine the processing units in the processing node that are respectively configured to run the scripts corresponding to the multiple data processing requests, by using multiple threads in parallel and according to the multiple data processing requests.

Optionally, the first relay node is configured to:
send a first data processing request in the multiple data processing requests to the target processing node, upon receiving multiple data processing requests sent by the target request node; and
send a second data processing request in the multiple data processing requests to the target processing node upon receiving a data processing response of the first data processing request.

Optionally, the first relay node is configured to: add the data processing request to a first queue upon receiving the data processing request sent by the target request node and send the data processing request in the first queue to the target processing node; and add the data processing response to a second queue and send the data processing response from the second queue to the target request node, after receiving a data processing response of the data processing request sent by the target processing node.

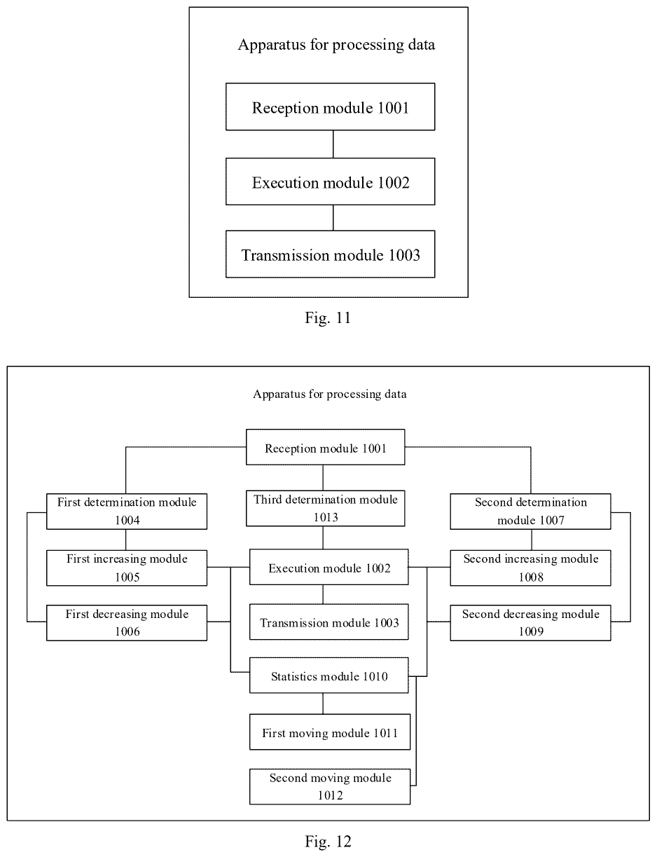

FIG. 11 is a schematic structural diagram of an apparatus for processing data according to an embodiment of the present disclosure. The apparatus for processing data is applied to the target processing node in the system for processing data. The system for processing data includes a first relay node, at least one request node, and at least one processing node, and the target processing node is any one of the at least one processing node. As shown in FIG. 11, the apparatus for processing data includes a reception module 1001, an execution module 1002 and a transmission module 1003.

The reception module 1001 is configured to receive a data processing request sent by the first relay node. The data processing request is sent to the first relay node by a target request node based on the data to be processed of the system for processing data. The target request node is any one of the at least one request node. The function of the reception module 1001 may refer to the content related to the target processing node receiving data processing requests in FIGS. 3, 7, 8, and 9, and the embodiments of the present disclosure will not be repeated here.

The execution module 1002 is configured to execute a data processing operation requested by the data processing request. The function of the execution module 1002 may refer to the content related to the target processing node executing data processing requests in FIGS. 3, 7, 8, and 9, and the embodiments of the present disclosure will not be repeated here.

The transmission module 1003 is configured to transmit a processing result of the data processing operation to the target request node. The function of the transmission module 1003 may refer to the content related to the target processing node transmitting data processing responses to the target request node in FIGS. 3, 7, 8, and 9, and the embodiments of the present disclosure will not be repeated here.

Optionally, the system for processing data further includes a second relay node, and the transmission module 1003 is configured to:
send the processing result to a second relay node; and
send a data processing response of the data processing request to the first relay node, such that the first relay node sends the data processing response to the target request node, and the target request node acquires the processing result from the second relay node based on the data processing response, and the data processing response is used to indicate that the processing result has been obtained.

Optionally, the data processing request carries data to be processed and an identifier of the script corresponding to the data processing request. The script corresponding to the data processing request is the script that needs to be run to execute the data processing operation requested by the data processing request. The execution module 1002 is configured to use a processing unit, which has been already created within the processing node to run the script corresponding to the data processing request, to execute the data processing operation.

Optionally, the data processing request sent by the first relay node includes different data processing requests corresponding to the same script; and data processing operations requested by the different data processing requests are executed by the same processing unit.

Optionally, as shown in FIG. 12, the apparatus for processing data, based on FIG. 11, further includes a first determination module 1004, a first increasing module 1005 and a first decreasing module 1006.

The first determination module 1004 is configured to determine a first number of the data processing requests received within the most recent first time period for many times. The function of the first determination module 1004 may refer to the content related to the target processing node determining the first number in FIGS. 3, 7, 8, and 9, and the embodiments of the present disclosure will not be repeated here.

The first increasing module 1005 is configured to increase the processing units in the target processing node in the case that the growth rate of the first number is greater than a first probability threshold, and the first probability threshold is greater than zero. The function of the first increasing module 1005 may refer to the content related to the target processing node increasing processing units in the case that the growth rate of the first number is greater than the first probability threshold in FIGS. 3, 7, 8, and 9, and the embodiments of the present disclosure will not be repeated here.

The first decreasing module 1006 is configured to decrease the processing units in the target processing node, in the case that the growth rate of the first number is less than a second probability threshold, and the second probability threshold is less than zero. The function of the first decreasing module 1006 may refer to the content related to the target processing node decreasing processing units in the case that the growth rate of the first number is less than the second probability threshold in FIGS. 3, 7, 8, and 9, and the embodiments of the present disclosure will not be repeated here.

Optionally, as shown in FIG. 12, the apparatus for processing data further includes a second determination module 1007, a second increasing module 1008 and a second decreasing module 1009.

The second determination module 1007 is configured to determine a second number of the data processing requests corresponding to the same script received within the most recent second time period for many times. The function of the second determination module 1007 may refer to the content related to the target processing node determining the second number in FIGS. 3, 7, 8, and 9, and the embodiments of the present disclosure will not be repeated here.

The second increasing module 1008 is configured to increase the processing units for running the same script in the target processing node in the case that the growth rate of the second number is greater than a third probability threshold, and the third probability threshold is greater than zero. The function of the second increasing module 1008 may refer to the content related to the target processing node increasing processing units in the case that the growth rate of the second number is greater than the third probability threshold in FIGS. 3, 7, 8, and 9, and the embodiments of the present disclosure will not be repeated here.

The second decreasing module 1009 is configured to decrease the processing units for running the same script in the target processing node in the case that the growth rate of the second number is less than a fourth probability threshold, and the fourth probability threshold is less than zero. The function of the second decreasing module 1009 may refer to the content related to the target processing node decreasing processing units in the case that the growth rate of the second number is less than the fourth probability threshold in FIGS. 3, 7, 8, and 9, and the embodiments of the present disclosure will not be repeated here.

Optionally, the system for processing data further includes a second relay node, and the target processing node is configured to (as the aforementioned first increasing module or the second increasing module is configured to): execute, in the case of increasing m processing units in the processing node, x script acquisition operations to obtain n scripts for the m processing units to run, where m≥x≥n≥1. One script acquisition operation corresponds to one script out of the n scripts. The script acquisition operation is configured to: acquire, in the case that a corresponding script is stored in the memory of the target processing unit, the corresponding script from the memory; send, in the case that the corresponding script is not stored in the memory, an acquisition request for the corresponding script to the second relay node and receive the corresponding script sent by the second relay node based on the acquisition request; and create the m processing units based on the n scripts.

Optionally, m>x=n.

Optionally, as shown in FIG. 12, the apparatus for processing data further includes a statistics module 1010, a first moving module 1011, and a second moving module 1012.

The statistics module 1010 is configured to conduct statistics on the frequency at which each script stored in the memory and the second relay node is run. The function of the statistics module may refer to the content related to the target processing node conducting statistics on the frequency of script running in FIGS. 3, 7, 8, and 9, and the embodiments of the present disclosure will not be repeated here.

The first moving module 1011 is configured to move the first script from the second relay node to the memory, in a cast that a first script stored in the second relay node is run at a frequency greater than a first frequency threshold.

The second moving module 1012 is configured to move a second script from the memory to the second relay node, in a case that the second script stored in the memory is run at a frequency greater than a second frequency threshold and less than or equal to the first frequency threshold.

The functions of the first moving module and the second moving module may refer to the content related to the target processing node moving scripts between the memory and the second relay node in FIGS. 3, 7, 8, and 9, and the embodiments of the present disclosure will not be repeated here.

Optionally, the apparatus for processing data further includes a third determination module 1013.

The third determination module 1013 is configured to use, upon receiving multiple data processing requests sent by the first relay node, multiple threads in parallel to, based on the multiple data processing requests, determine the processing units in the processing node that are configured respectively to run the scripts corresponding to the multiple data processing requests. The function of the third determination module may refer to the content related to the target processing node using multiple threads in parallel to determine processing units in FIGS. 3, 7, 8, and 9, and the embodiments of the present disclosure will not be repeated here.

In summary, the system for processing data provided in the present disclosure includes a first relay node, at least one request node, and at least one processing node. As can be seen from the functions of the apparatus for processing data provided in the embodiments of the present disclosure, each request node can send a data processing request to any processing node via the first relay node, so as to make the processing node to execute the data processing operation requested by the data processing request and transmit the result of the data processing operation to the request node. It can be seen that, based on the system for processing data provided in the present disclosure, the present disclosure provides a new method for processing data, and enriches the methods for processing data.

In addition, the system for processing data and the method for processing data provided in the present disclosure can decouple the request node from the processing node, so that the number of both the request nodes and the processing nodes can be expanded. Moreover, in the case that the number of at least one of the request nodes and the processing nodes is expanded, the performance of the system for processing data will be changed. Therefore, the present disclosure can support the flexible adjustment of the performance of the system for processing data.

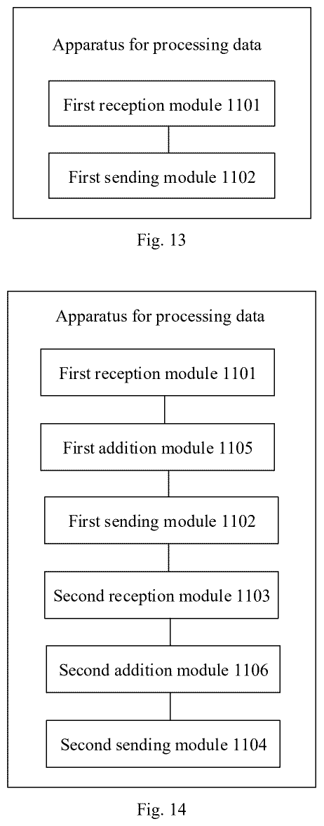

FIG. 13 is a schematic structural diagram of another apparatus for processing data according to an embodiment of the present disclosure. The apparatus for processing data is applied to the first relay node in the system for processing data. The system for processing data further includes at least one request node and at least one processing node. As shown in FIG. 13, the apparatus for processing data includes a first reception module 1101 and a first sending module 1102.

The first reception module 1101 is configured to receive a data processing request sent by the target request node. The data processing request is sent by the target request node based on the data to be processed of the system for processing data. The target request node is any one of the at least one request node. The function of the first reception module 1101 may refer to the content related to the first relay node receiving data processing requests in FIGS. 3, 7, 8, and 9, such as step 301, and the embodiments of the present disclosure will not be repeated here.

The first sending module 1102 is configured to send the data processing request to the target processing node, such that the target processing node executes the data processing operation requested by the data processing request and transmits the processing result of the data processing operation to the target request node. The target processing node is any one of the at least one processing node. The function of the first sending module 1102 may refer to the content related to the first relay node sending data processing requests in FIGS. 3, 7, 8, and 9, such as step 302, and the embodiments of the present disclosure will not be repeated here.

Optionally, the system for processing data further includes a second relay node, and the target processing node is configured to send the processing results to the second relay node. As shown in FIG. 14, the apparatus for processing data, based on FIG. 13, further includes a second reception module 1103 and a second sending module 1104.

The second reception module 1103 for receiving the data processing response of the data processing request sent by the target processing node, and the data processing response is used to indicate that the processing result has been obtained. The function of the second reception module may refer to the content related to the first relay node receiving data processing responses in FIGS. 3, 7, 8, and 9, and the embodiments of the present disclosure will not be repeated here.

The second sending module 1104 is configured to send the data processing response to the target request node, such that the target request node acquires the processing result from the second relay node based on the data processing response. The function of the second sending module may refer to the content related to the first relay node sending data processing responses in FIGS. 3, 7, 8, and 9, and the embodiments of the present disclosure will not be repeated here.

Optionally, the first sending module 1101 is configured to:
send a first data processing request in the multiple data processing requests to the target processing node upon receiving multiple data processing requests sent by the target request node; and
send a second data processing request in the multiple data processing requests to the target processing node, upon receiving a data processing response of the first data processing request.

Optionally, as shown in FIG. 14, the apparatus for processing data further includes a first addition module 1105 and a second addition module 1106.

The first addition module 1105 is configured to add the data processing request to the first queue. The function of the first addition module may refer to the content related to the first relay node adding data processing requests to the first queue in FIGS. 3, 7, 8, and 9, and the embodiments of the present disclosure will not be repeated here.

The second addition module 1106 is configured to add the data processing response to the second queue. The function of the second addition module may refer to the content related to the first relay node adding data processing responses to the second queue in FIGS. 3, 7, 8, and 9, and the embodiments of the present disclosure will not be repeated here.

The first sending module 1101 is configured to send the data processing request in the first queue to the target processing node.

The second sending module 1104 is configured to send the data processing response from the second queue to the target request node.

In summary, the system for processing data provided in the present disclosure includes a first relay node, at least one request node, and at least one processing node. As can be seen from the functions of the apparatus for processing data provided in the embodiments of the present disclosure, each request node can send a data processing request to any processing node via the first relay node, so as to make the processing node to execute the data processing operation requested by the data processing request and transmit the result of the data processing operation to the request node. It can be seen that, based on the system for processing data provided in the present disclosure, the present disclosure provides a new method for processing data, and enriches the methods for processing data.

In addition, the system for processing data and the method for processing data provided in the present disclosure can decouple the request node from the processing node, so that the number of both the request nodes and the processing nodes can be expanded. Moreover, in the case that the number of at least one of the request nodes and the processing nodes is expanded, the performance of the system for processing data will be changed. Therefore, the present disclosure can support the flexible adjustment of the performance of the system for processing data.

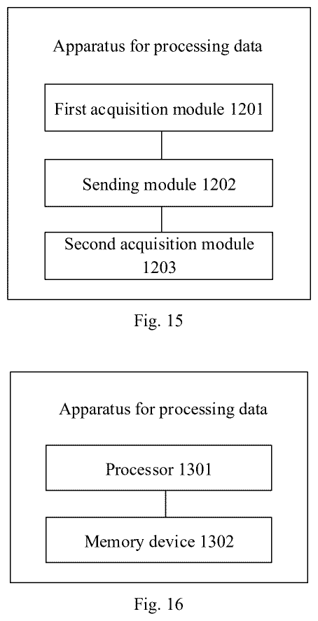

FIG. 15 is a schematic structural diagram of another apparatus for processing data according to an embodiment of the present disclosure. The apparatus for processing data is applied to the target request node in the system for processing data. The system for processing data includes a first relay node, at least one request node, and at least one processing node, with the target request node being any one of the at least one request node. As shown in FIG. 15, the apparatus for processing data includes a first acquisition module 1201, a sending module 1202 and a second acquisition module 1203.

The first acquisition module 1201 is configured to acquire the data to be processed of the system for processing data. The function of the first acquisition module 1201 may refer to the content related to the target request node acquiring data to be processed in FIGS. 3, 7, 8, and 9, such as step 401, and the embodiments of the present disclosure will not be repeated here.

The sending module 1202 is configured to send a data processing request to the first relay node based on the data to be processed, such that the first relay node sends the data processing request to the target processing node, and the target processing node executes the data processing operation requested by the data processing request. The target processing node is any one of the at least one processing node. The function of the sending module 1202 may refer to the content related to the target request node sending data processing requests to the first relay node in FIGS. 3, 7, 8, and 9, such as step 402, and the embodiments of the present disclosure will not be repeated here.

The second acquisition module 1203 is configured to acquire the processing result of the data processing operation from the target processing node. The function of the second acquisition module 1203 may refer to the content related to the target request node acquiring processing results from the first relay node in FIGS. 3, 7, 8, and 9, such as step 403, and the embodiments of the present disclosure will not be repeated here.

Optionally, the system for processing data further includes a second relay node, and the target processing node is configured to send the processing result to the second relay node and send a data processing response of the data processing request to the first relay node, and the data processing response is used to indicate that the processing result has been obtained.

The second acquisition module 1203 is configured to: receive the data processing response sent by the first relay node; and acquire the processing result from the second relay node based on the data processing response.

In summary, the system for processing data provided in the present disclosure includes a first relay node, at least one request node, and at least one processing node. As can be seen from the functions of the apparatus for processing data provided in the embodiments of the present disclosure, each request node can send a data processing request to any processing node via the first relay node, so as to make the processing node to execute the data processing operation requested by the data processing request and transmit the result of the data processing operation to the request node. It can be seen that, based on the system for processing data provided in the present disclosure, the present disclosure provides a new method for processing data, and enriches the methods for processing data.

In addition, the system for processing data and the method for processing data provided in the present disclosure can decouple the request node from the processing node, so that the number of both the request nodes and the processing nodes can be expanded. Moreover, in the case that the number of at least one of the request nodes and the processing nodes is expanded, the performance of the system for processing data will be changed. Therefore, the present disclosure can support the flexible adjustment of the performance of the system for processing data.

FIG. 16 illustrates another apparatus for processing data according to an embodiment of the present disclosure. As shown in FIG. 16, the apparatus for processing data includes a processor 1301 and a memory device 1302. The memory device 1302 stores programs, and the processor 1301 is configured to run the programs stored in the memory device 1302 to implement any one of the methods for processing data provided in the embodiments of the present disclosure and applied to any one of the nodes (such as the target request node, the first relay node, the target processing node, etc.) in the system for processing data. The methods are applicable to any such node, as illustrated in the methods for processing data shown in FIG. 3, 7, 8, or 9.

The embodiments of the present disclosure further provide a non-transitory computer-readable storage medium. The computer-readable storage medium stores instructions. The instructions, when executed on a computer, cause the computer to perform any one of the methods for processing data provided in the embodiments of the present disclosure and applied to any one of the nodes (such as the target request node, the first relay node, the target processing node, etc.) in the system for processing data. The methods are applicable to any such node, as illustrated in the methods for processing data shown in FIG. 3, 7, 8, or 9.

The embodiments of the present disclosure further provide a computer program product containing instructions. The computer program product, when running on a computer, causes the computer to perform any one of the methods for processing data provided in the embodiments of the present disclosure and applied to any one of the nodes (such as the target request node, the first relay node, the target processing node, etc.) in the system for processing data. The methods are applicable to any such node, as illustrated in the methods for processing data shown in FIG. 3, 7, 8, or 9.

It should be noted that the data involved in the present disclosure (including but not limited to data for processing, data for storage, etc.) is all obtained with the authorization of the user or through the sufficient authorization of all parties involved, and the collection, use, and processing of the relevant data must comply with relevant laws, regulations, and standards of the respective countries and regions. For example, the data to be processed involved in the present disclosure is all acquired under sufficient authorization.

In the present disclosure, the terms “first” and “second” are used for descriptive purposes only and should not be construed as indicating or implying relative importance. The term “a plurality of” refers to two or more, unless otherwise explicitly defined.

It should be noted that the method embodiments provided in the embodiments of the present disclosure can refer to the corresponding apparatus embodiments, and the embodiments of the present disclosure do not impose any limitations on this aspect. The order of the steps in the method embodiments provided in the embodiments of the present disclosure can be appropriately adjusted, and steps can also be added or removed as needed. Any variations of the methods that may be envisaged by those skilled in the art within the technical scope disclosed herein should fall within the protection scope of the present disclosure. Therefore, further elaboration is not necessary.

1. A method for processing data, wherein the method is applied to a target processing node in a system for processing data, the system for processing data comprises a first relay node, at least one request node and at least one processing node, the target processing node is any one of the at least one processing node, and the method comprises:
receiving a data processing request sent by the first relay node, wherein the data processing request is sent to the first relay node by a target request node based on data to be processed of the system for processing data, and the target request node is any one of the at least one request node;
executing a data processing operation requested by the data processing request; and
transmitting a processing result of the data processing operation to the target request node.

2. The method according to claim 1, wherein the system for processing data further comprises a second relay node, and the transmitting the processing result of the data processing operation to the target request node comprises:
sending the processing result to the second relay node; and
sending a data processing response of the data processing request to the first relay node, such that the first relay node sends the data processing response to the target request node, and the target request node acquires the processing result from the second relay node based on the data processing response, wherein the data processing response is used to indicate that the processing result has been obtained.

3. The method according to claim 1, wherein the data processing request carries an identifier of a script corresponding to the data processing request; and the script corresponding to the data processing request is a script that needs to be run to execute the data processing operation requested by the data processing request; and
the executing the data processing operation requested by the data processing request comprises:
using a processing unit, which has been created within the processing node and is configured to run the script corresponding to the data processing request, to execute the data processing operation.

4. The method according to claim 3, wherein the data processing request sent by the first relay node comprises different data processing requests corresponding to a same script and data processing operations requested by the different data processing requests are executed by a same processing unit.

5. The method according to claim 3, further comprising:
determining a first number of the data processing requests received within a most recent first time period for many times;
increasing the processing unit in the target processing node, in a case that a growth rate of the first number is greater than a first probability threshold, wherein the first probability threshold is greater than zero; and
decreasing the processing unit in the target processing node, in a case that the growth rate of the first number is less than a second probability threshold, wherein the second probability threshold is less than zero.

6. The method according to claim 3, further comprising:
determining a second number of the data processing requests corresponding to a same script received within a most recent second time period for many times;
increasing a processing unit for running the same script in the target processing node, in a case that a growth rate of the second number is greater than a third probability threshold, wherein the third probability threshold is greater than zero; and
decreasing the processing unit for running the same script in the target processing node, in a case that the growth rate of the second number is less than a fourth probability threshold, wherein the fourth probability threshold is less than zero.

7. The method according to claim 5, wherein the system for processing data further comprises a second relay node, and the target processing node is configured to:
execute x script acquisition operations to obtain n scripts for m processing units to run, in a case that the m processing units in the processing node are increased, wherein m≥x≥n≥1, one said script acquisition operation corresponds to one script out of the n scripts, and the script acquisition operation is configured to: acquire a corresponding script from a memory, in a case that the corresponding script is stored in the memory of the target processing unit; send an acquisition request for a corresponding script to the second relay node and receive the corresponding script sent by the second relay node based on the acquisition request, in a case that the corresponding script is not stored in the memory; and
create the m processing units based on the n scripts.

8. The method according to claim 7, wherein m>x=n.

9. The method according to claim 7, further comprising:
conducting statistics on frequency at which each script stored in the memory and the second relay node is run;
moving a first script stored in the second relay node from the second relay node to the memory, in a cast that the first script is run at a frequency greater than a first frequency threshold; and
moving a second script stored in the memory from the memory to the second relay node, in a cast that the second script is run at a frequency greater than a second frequency threshold and less than or equal to the first frequency threshold.

10. The method according to claim 3, wherein before executing the data processing operation requested by the data processing request, the method further comprises:
determining processing units in the processing node that are respectively configured to run scripts corresponding to multiple data processing requests, by using multiple threads in parallel and according to the multiple data processing requests, upon receiving the multiple data processing requests sent by the first relay node.

11. A method for processing data, wherein the method is applied to a first relay node in a system for processing data, the system for processing data further comprises at least one request node and at least one processing node, and the method comprises:
receiving a data processing request sent by a target request node, wherein the data processing request is sent by the target request node based on data to be processed of the system for processing data, and the target request node is any one of the at least one request node; and
sending the data processing request to a target processing node, such that the target processing node executes a data processing operation requested by the data processing request and transmits a processing result of the data processing operation to the target request node, and the target processing node is any one of the at least one processing node.

12. The method according to claim 11, wherein the system for processing data further comprises a second relay node, the target processing node is configured to send the processing result to the second relay node, and the method further comprises:
receiving a data processing response of the data processing request sent by the target processing node, wherein the data processing response is used to indicate that the processing result has been obtained; and
sending the data processing response to the target request node, such that the target request node acquires the processing result from the second relay node based on the data processing response.

13. The method according to claim 12, wherein the sending the data processing request to the target processing node comprises:
sending a first data processing request in multiple data processing requests to the target processing node, upon receiving the multiple data processing requests sent by the target request node; and
sending a second data processing request in the multiple data processing requests to the target processing node, upon receiving a data processing response of the first data processing request.

14. The method according to claim 12, wherein after receiving a data processing request sent by the target request node, the method further comprises: adding the data processing request to a first queue;
the sending the data processing request to the target processing node comprises: sending the data processing request in the first queue to the target processing node;
after receiving the data processing response of the data processing request sent by the target processing node, the method further comprises:
adding the data processing response to a second queue; and
the sending the data processing response to the target request node comprises:
sending the data processing response from the second queue to the target request node.

15. A method for processing data, wherein the method is applied to a target request node in a system for processing data, the system for processing data comprises a first relay node, at least one request node and at least one processing node, the target request node is any one of the at least one request node, and the method comprises:
acquiring data to be processed of the system for processing data;
sending a data processing request to the first relay node based on the data to be processed, such that the first relay node sends the data processing request to a target processing node, the target processing node executes a data processing operation requested by the data processing request, and the target processing node is any one of the at least one processing node; and
acquiring a processing result of the data processing operation from the target processing node.

16. The method according to claim 15, wherein the system for processing data further comprises a second relay node, and the target processing node is configured to send the processing result to the second relay node and send a data processing response of the data processing request to the first relay node, wherein the data processing response is used to indicate that the processing result has been obtained;
the acquiring the processing result of the data processing operation from the target processing node comprises:
receiving the data processing response sent by the first relay node; and
acquiring the processing result from the second relay node, based on the data processing response.

17. An apparatus for processing data, comprising a processor and a memory device, wherein the memory device stores programs, and the processor is configured to run the programs stored in the memory device to implement the method for processing data as defined in claim 1.

18. A system for processing data, comprising a first relay node, at least one request node, and at least one processing node, wherein
the processing node is configured to perform the method for processing data as defined in claim 1.

19. A non-transitory computer-readable storage medium storing instructions, wherein the instructions, when executed on a computer, cause the computer to perform the method for processing data as defined in claim 1.

20. A computer program product comprising instructions, wherein the computer program product, when running on a computer, causes the computer to perform the method for processing data as defined in claim 1.
